(19) United States
(12) Patent Application Publication
(10) Pub. No.: US 2004/0064562 A1
(43) Pub. Date: Apr. 1, 2004

(54) Interface or communicating device for network facility

(76) Inventor: John Huang, Hsin Chuan City (TW)

Correspondence Address: John Huang, P.O. Box 4-67, Hsin Chung, Taipei, 242, TW

(21) Appl. No.: 10/261,526

(22) Filed: Sep. 27, 2002

(51) Int. Cl. G06F 15/16

(52) U.S. Cl. 709/227

(57) ABSTRACT

A network facility includes an accessor device coupled to a network device, and another accessor device coupled to one or more end users and having a processor device for communicating with the accessor device of the network device. The processor device includes a receiving device communicated with the end users, and having a device for identifying whether the end users are acceptable or not, and another device for compensating the end users to communicate with the network device. The end user may thus be communicated with the network device whether acceptable or not.

### BACKGROUND OF THE INVENTION

1. Field of the Invention

The present invention relates to a network facility, and more particularly to a network facility having an interface or communicating device for suitably coupling or communicating with the end users.

2. Description of the Prior Art

A typical network facility is illustrated in FIG. 1 and comprises a number of end users A1 each having a card A2, such as a local area network (LAN) card A2, or a wireless local area network (WLAN) card A2, or a connecting member A3, for coupling to or for communicating with a WLAN accessor device A4 which is coupled to a LAN device AS.

The end users have to prepare and carry the LAN or WLAN card A2 and/or the connecting member A3 with them, or should borrow or rent the LAN or WLAN card A2 and/or the connecting member A3 from the other persons or from the particular stores. In addition, some of the LAN or WLAN card A2 and/or the connecting member A3 may not be compatible or communicated with the accessor device A4. It will thus be difficult or inconvenient for the end users to communicate with the network facility.

The present invention has arisen to mitigate and/or obviate the afore-described disadvantages of the conventional network facilities.

### SUMMARY OF THE INVENTION

The primary objective of the present invention is to provide a network facility including an interface or communicating device for suitably coupling or communicating with the end users and for allowing the end users to easily and conveniently communicate with the network facility or system.

In accordance with one aspect of the invention, there is provided a network facility comprising a network device, such as a LAN or WLAN device, a first accessor device coupled to the network device, at least one end user, and a second accessor device coupled to the end user and including a processor unit for communicating with the first accessor device of the network device. The processor unit includes a first receiving device having a device for communicating with the end user, and another device for identifying whether the end user is acceptable or not, and a further device for compensating the end user to communicate with the first accessor device of the network device when the end user is not acceptable. The end user may thus acceptable to be communicated or coupled to the network device whether the end user has the required network card or not.

The first receiving device of the processor unit includes a transmitting device for communicating the end user with the first accessor device of the network device when the end user is both acceptable or not acceptable, and for allowing the end user to easily and readily communicate with and couple to the network device.

The processor unit includes a second receiving device having a device for communicating the first accessor device of the network device to receive information from the first accessor device of the network device, and another device for checking whether the information from the first accessor device of the network device is acceptable or not.

The second receiving device of the processor unit includes a transmitting device for transmitting the information to the end user when the information from the first accessor device of the network device is acceptable.

The second receiving device of the processor unit includes a device for identifying whether the information from the first accessor device of the network device is the required information or not, and for removing the junk or waste or unwanted information, and for preventing the memory spaces of the end user from being occupied by the junk or waste or unwanted information.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plan schematic view illustrating a typical network facility;

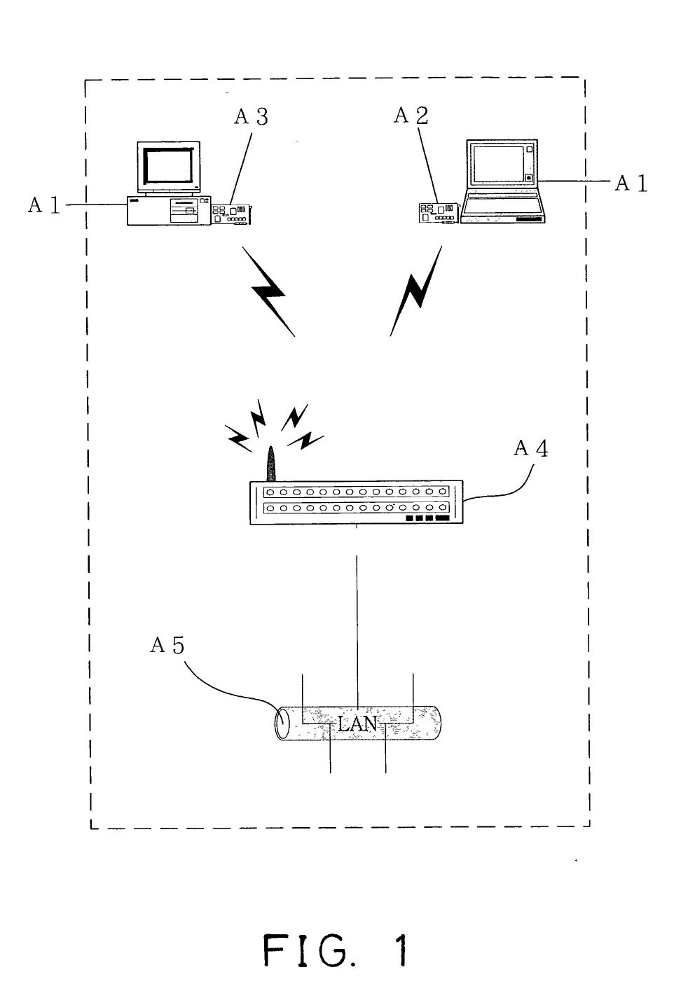

FIG. 2 is a plan schematic view illustrating a network facility in accordance with the present invention;

FIG. 3 is a block diagram illustrating the accessor device of the network facility;

FIG. 4 is a flow chart illustrating the communication from the end user to the LAN or WLAN of the network facility; and

FIG. 5 is another flow chart illustrating the communication from the LAN or WLAN of the network facility to the end users.

### DETAILED DESCRIPTION OF THE PREFERRED EMBODIMENT

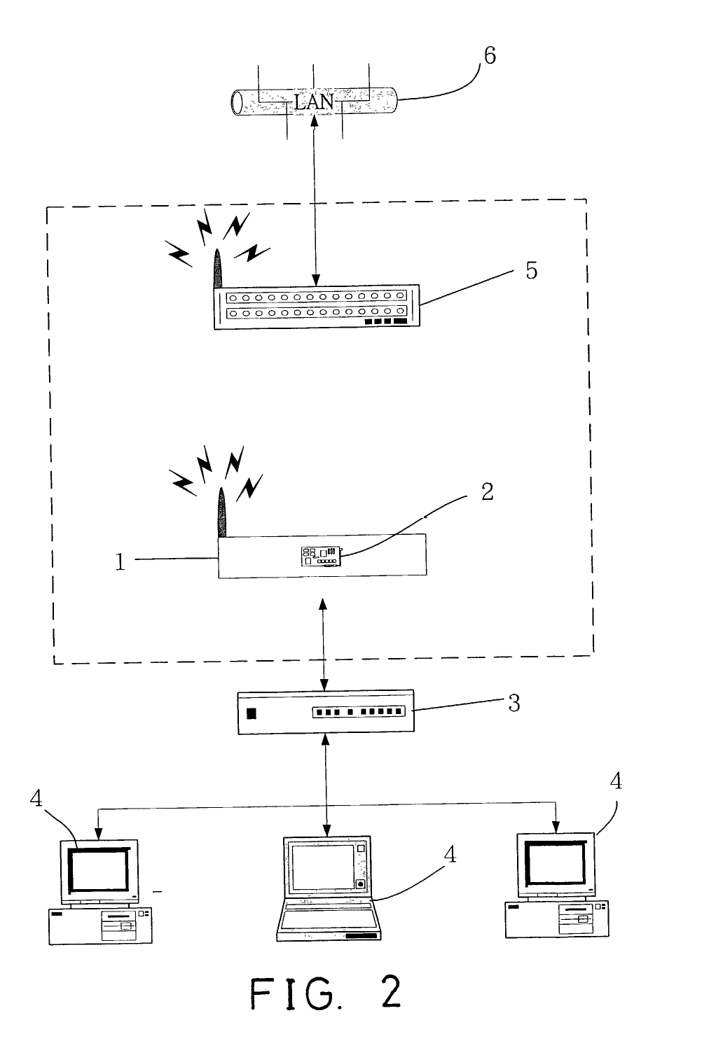

Referring to the drawings, and initially to FIG. 2, a network facility in accordance with the present invention comprises an accessor device 1 including a control or processor unit 2 disposed and provided therein, and directly coupled to one or more end users 4, such as the personal computers or the notebook computers, with wires or wireless. or indirectly coupled to the end users 4 via an adapter 3.

The network facility further includes another accessor device 5 coupled to or communicating with a local area network (LAN) or wireless local area network (WLAN) device 6. The processor unit 2 is provided for communicating between the end users 4 and the LAN or WLAN or network device 6.

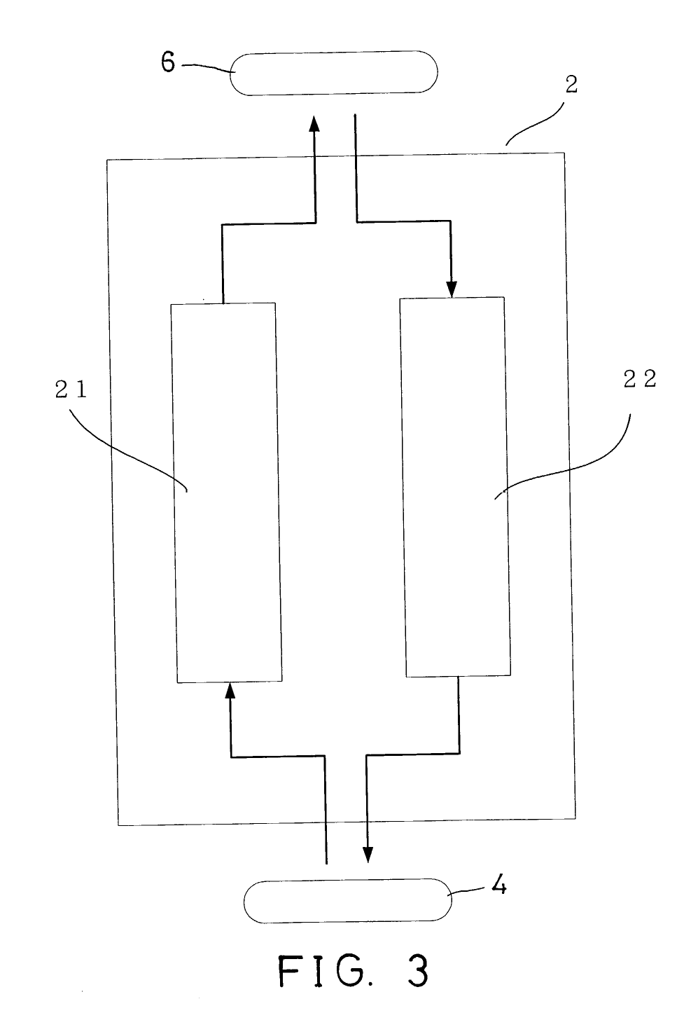

As shown in FIG. 3, the processor unit 2 includes a receiving circuit or program or device 21 for communicating the end users 4 to the LAN or WLAN device 6; and includes another receiving circuit or program or device 22 for communicating LAN or WLAN device 6 to the end users 4.

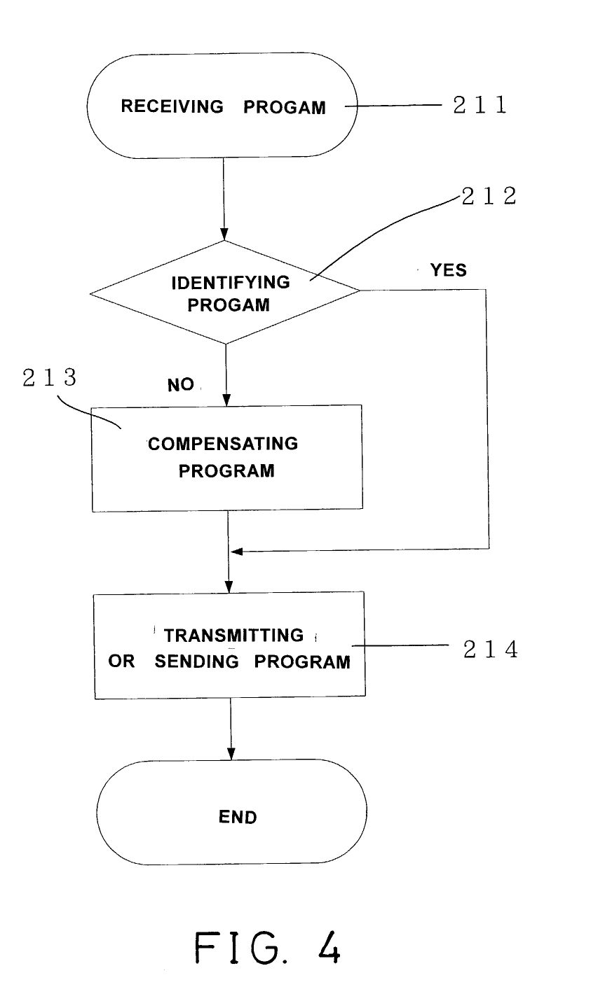

For example, as shown in FIG. 4, the receiving device 21 includes a receiving program or circuit 211 for receiving signals, such as processing or control information or signals, from the end users 4. The information or signals are then sent to an identifying program or circuit 212 for detecting or judging or identifying whether the initial information or addresses from the end users 4 are acceptable or not.

For example, the acceptable information or addresses of the end users 4 may be listed or stored in the processor unit 2, and may be compared with the initial information or addresses from the end users 4, in order to identify whether the initial information or addresses from the end users 4 are acceptable or not or are listed or stored in the processor unit 2 or not.

If the initial information or addresses from the end users 4 are acceptable or are listed or stored in the processor unit 2, the signals or information may then be directly sent to a transmitting or sending program or circuit 214 for directly sending the information or signals to the accessor device 5 of the LAN or WLAN device 6.

On the contrary, if the initial information or addresses from the end users 4 are not acceptable or are not listed or stored in the processor unit 2, the signals or information may then be sent to the transmitting or sending program or circuit 214 indirectly via a compensating program or circuit 213, before sending the information or signals to the accessor device 5 of the LAN or WLAN device 6.

The compensating program or circuit 213 may send out the required or predetermined protocal or identification data or information or signals to the transmitting or sending program or circuit 214 for the end users 4; and may send the information or signals out to the accessor device 5 of the LAN or WLAN device 6 for the end users 4.

Accordingly, the processor unit 2 may be used for communicating or for sending the information or signals out to the accessor device 5 of the LAN or WLAN device 6 for the end users 4, when the end users 4 either have or have no compatible LAN or WLAN card or not.

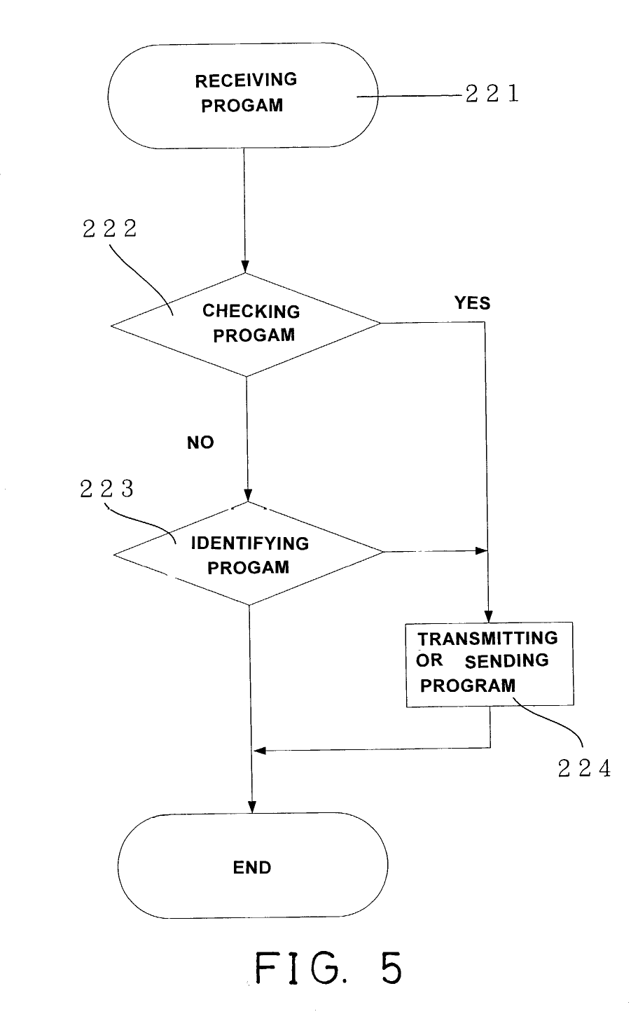

As shown in FIG. 5, the another receiving circuit or program or device 22 includes a receiving program or circuit 221 for receiving signals, such as processing or control information or signals, from such as the accessor device 5 of the LAN or WLAN device 6. The information or signals are then sent to a checking program or circuit 222 for information or signals checking or judging or identifying purposes.

For example, the checking program or circuit 222 may be used for checking or judging whether the information or signals from the accessor device 5 of the LAN or WLAN device 6 are acceptable or not or are from the predetermined LAN or WLAN devices 6.

Furthermore, for example, the acceptable information or signals of the LAN or WLAN devices 6 may be listed or stored in the processor unit 2, and may be compared with the newly entered or received information or signals from the LAN or WLAN devices 6, in order to identify whether the information or signals are acceptable or not or are listed or stored in the processor unit 2 or not.

If the information or signals from the accessor device 5 of the LAN or WLAN device 6 are acceptable or are listed or stored in the processor unit 2, the signals or information may then be directly sent to a transmitting or sending program or circuit 224 for directly sending the information or signals to the end users 4.

On the contrary, if the information or signals from the accessor device 5 of the LAN or WLAN device 6 are not acceptable or are not listed or stored in the processor unit 2, the signals or information may then be sent to an identifying program or circuit 223 to identify the information or signals are the required information or signals or not.

For example, the identifying program or circuit 223 may be used to check or determine whether the received information or signals are for marketing purposes, or for advertising purposes, or are junk or not.

For example, if the received information or signals are not the required information or signals, the received information or signals will not be sent to the transmitting or sending program or circuit 224 and thus will not be sent to the end users 4, in order to avoid the waste or junk from occupying the memory spaces of the end users 4.

On the contrary, if the received information or signals are the required information or signals, the received information or signals will then be sent to the transmitting or sending program or circuit 224 and thus will then be sent to the end users 4, for allowing the end users 4 to be swiftly communicated or coupled to the accessor device 5 of the LAN or WLAN device 6.

Accordingly, the processor unit 2 may also be used for communicating or for receiving the required information or signals from the accessor device 5 of the LAN or WLAN device 6 for the end users 4, and for facilitating the communication between the accessor device 5 of the LAN or WLAN device 6 and the end users 4.

Accordingly, the network facility in accordance with the present invention includes an interface or communicating device for suitably coupling or communicating with the end users and for allowing the end users to easily and conveniently communicate with the network facility or system.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A network facility comprising:
a network device,
a first accessor device coupled to said network device,
at least one end user, and
a second accessor device coupled to said at least one end user, said second accessor device including a processor unit for communicating with said first accessor device of said network device, and
said processor unit including a first receiving device having means for communicating with said at least one end user, and means for identifying whether said at least one end user is acceptable or not, and means for compensating said at least one end user to communicate with said first accessor device of said network device when said at least one end user is not acceptable.

2. The network facility according to claim 1, wherein said first receiving device of said processor unit includes a transmitting means for communicating said at least one end user with said first accessor device of said network device when said at least one end user is both acceptable or not acceptable.

3. The network facility according to claim 1, wherein said processor unit includes a second receiving device having means for communicating said first accessor device of said network device to receive information from said first accessor device of said network device, and means for checking whether the information from said first accessor device of said network device is acceptable or not.

4. The network facility according to claim 3, wherein said second receiving device of said processor unit includes a transmitting means for transmitting the information to said at least one end user when the information from said first accessor device of said network device is acceptable.

5. The network facility according to claim 3, wherein said second receiving device of said processor unit includes means for identifying whether the information from said first accessor device of said network device is the required information or not.
